(19) United States
(12) Patent Application Publication
(10) Pub. No.: US 2002/0030768 A1
(43) Pub. Date: Mar. 14, 2002

(54) Integrated high resolution image sensor and display on an active matrix array with micro-lens

(76) Inventor: I-Wei Wu, Hsinchu (TW)

Correspondence Address: Jason Z. Lin, 19597 Via Monte Drive, Saratoga, CA, 95070, US

(21) Appl. No.: 09/991,558

(22) Filed: Nov. 14, 2001

Related U.S. Application Data
(63) Continuation-in-part of application No. 09/270,220, filed on Mar. 15, 1999.

(51) Int. Cl. G02F 1/136; G02F 1/1335

(52) U.S. Cl. 349/42; 349/106

(57) ABSTRACT

An integrated image sensor and display device includes both display and sensor thin-film transistors as well as image sensors in the active matrix array of a liquid crystal display. The display thin-film transistors and the liquid crystals control the brightness of a displayed image. The sensor thin-film transistors control the operation of the image sensors. A color filter is disposed between two semiconductor substrates of the device. A microlens is placed on the backside of the active matrix array substrate to focus and direct backlight through a display aperture. Another microlens is constructed on the side facing a user to focus and direct the outside image onto the image sensor of the active matrix array.

### CROSS-REFERENCES TO RELATED APPLICATIONS

This is a continuation-in-part of U.S. application Ser. No. 09/270,220, filed Mar. 15, 1999.

### FIELD OF THE INVENTION

The present invention relates generally to an active matrix liquid crystal display, and more specifically to an active matrix liquid crystal display having integrated image sensors and micro-lenses.

### BACKGROUND OF THE INVENTION

LCD displays have been widely used as display devices in the electronics industry. The light weight and small volume of a liquid crystal display (LCD) have made it a very popular display means in many electronic devices such as notebook computers, palm top personal assistants, and portable video game systems. Most of these electronic devices require both an output display and an input sensor for user interface.

For low resolution applications, touch panels are often used on an LCD or CRT display to allow users to enter commands or data. Sensors on those touch panels have relatively low density and resolution. Therefore, the bandwidth of the input information is very limited and the speed of the input data is also slow. For higher resolution applications, there is a strong demand in having input sensors of both higher density and faster response.

In order to meet the requirement of an input sensor with high resolution and speed, an independent sensor or scanner is generally used along with an output display in an electronic device. In such a device, the high performance and function of an input sensor and a display device can be achieved. Nevertheless, the interface to the input sensor and the output device becomes cumbersome and the cost is high. For instance, to match the color represented by a display to that sensed by an image sensor is not an easy task. It is desirable that a high density input sensor and a high resolution output device be integrated into one unit so that the user interface of an electronic device can be accomplished with a system in one panel, and the faithfulness of both spatial registration and color representation can be easily assured.

### SUMMARY OF THE INVENTION

This invention has been made to meet the above-mentioned demand of an integrated input sensor and display device with both high bandwidth and resolution. The primary object of this invention is to provide an active matrix array having both display and sensor thin-film transistors as well as image sensors for a liquid crystal display. It is also an object of this invention to provide a device structure for designing and fabricating such an integrated high resolution image sensor and display.

According to this invention, each cell unit in the active matrix array has a display thin-film transistor for controlling the liquid crystals in the unit cell. It also includes an image sensor diode and a sensor thin-film transistor for detecting incident light of an imaged object. By incorporating image sensors into a liquid crystal display, an image display and sensor system can be fabricated in one panel to achieve high display resolution as well as high input bandwidth.

It is a further object of the invention to provide a device structure for an integrated image sensor and display with a color filter. Different structures of fabricating and integrating the color filter are provided so that both image sensor and image display have color capability.

The present invention also provides a device structure for a panel that includes microlenses for both image sensor and display. Microlenses can be fabricated by coating an appropriate material on the transparent substrates of the panel. A display microlens acts as a focusing element to direct the backlight through a display aperture. A sensor microlens is used to focus and direct the outside image onto the image sensor diode. For imaging a flat and/or opaque object, the display backlight can be used as the light source and the sensor as a contact image sensor. For imaging object of normal viewing distance, the microlens can be designed to have a focal distance in the appropriate range.

The foregoing and other objects, features, aspects and advantages of the present invention will become more apparent from a careful reading of a detailed description provided herein below, with appropriate reference to the accompanying drawings.

### BRIEF DESCRIPTION OF THE DRAWINGS

FIG. 1 shows an equivalent circuit of the integrated image sensor and display active matrix array of the present invention.

FIG. 2 shows a block diagram of the integrated image sensor and display active matrix array of the present invention and its peripheral circuits.

FIG. 3 shows a cross-sectional view of the integrated image sensor and display device of the present invention in which a color filter is fabricated between the liquid crystal layer and the upper glass substrate.

FIG. 4 shows a cross-sectional view of the integrated image sensor and display device of the present invention in which a color filter is fabricated on top of a planarization layer.

FIG. 5 shows a cross-sectional view of the integrated image sensor and display device of the present invention in which a color filter is also used as the planarization layer.

### DETAILED DESCRIPTION OF THE INVENTION

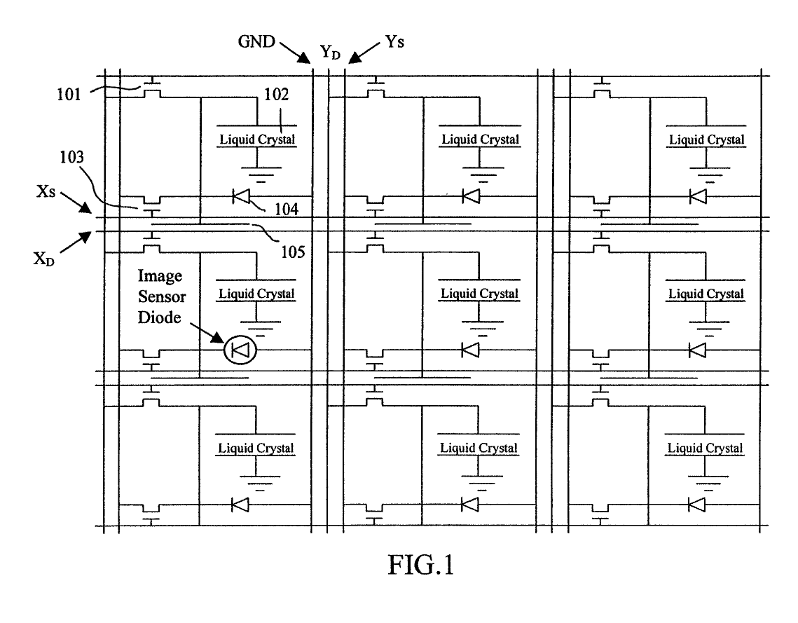

With reference to FIG. 1, an equivalent circuit of the integrated image sensor and display cell array of this invention is illustrated. The equivalent circuit has a display cell array with display thin-film transistors 101. Each display thin-film transistor 101 of a display cell controls the liquid crystals 102 in a pixel area to give the desired brightness of the pixel. Horizontal and vertical address lines X_{D} and Y_{D} allow each display cell to be scanned and selected. The equivalent circuit also has an image sensor array with sensor thin-film transistors 103. Each sensor thin-film transistor 103 is connected to an image sensor diode 104. Horizontal and vertical address lines X_{S} and Y_{S} allow each image sensor to be scanned and selected. In addition, the integrated image sensor and display cell array has an array of storage capacitors 105.

As shown in FIG. 1, the integrated image sensor and display cell array provides both input and output functions. The image sensor diode 104 serves as the input device and the display cell with liquid crystals 102 is the output device. The image sensor and the display cell have separate address lines to control them separately. Therefore, input signals and output signals can be received and displayed respectively at the same time. The operation of the integrated image sensor and display cell array can be controlled very flexibly dependent on the application.

The integrated image sensor and display cell array as shown in FIG. 1 provides both input and output functions. Each unit on the array comprises both an image display cell unit and an image sensor unit. The active thin-film transistors can be controlled separately through their respective address lines. In the operation of the integrated cell array, all the display cell units can be addressed first before the image sensor units are addressed. It is also feasible to alternatively address the display cell unit and the sensor unit in each unit before the next unit in the integrated cell array is addressed.

A display thin film transistor 101 can be turned on by an address line X_{D} to display an output video signal of a pixel through the address line Y_{D}. The pixel is then turned off by the address line X_{D} and the image sensor diode 104 is turned on by the address line X_{S} for reading an input image signal through the address line Y_{S}. The image sensor diode is then turned off by the address line X_{S} so that the same operation can be executed repeatedly for other image sensor and display cell in the array by controlling each address lines X_{D} and X_{S}. In the above operation, the sequence of displaying an output video signal and reading an input image signal in a pixel area can be reversed. It should also be noted that using an address line X_{S} to turn on an image sensor diode 104 can be executed at the same time when an address line X_{D} is used to turn on a thin film transistor 101. Therefore, the two address lines X_{D} and X_{S} can be combined in the design.

Another type of operations can also be executed with the integrated image sensor and display cell array of this invention. In the operation, each thin film transistor 101 is turned on by an address line X_{D} to display an output video signal of each pixel through each address line Y_{D} sequentially. After all thin film transistors have been turned on and off, each image sensor diode 104 is then turned on sequentially by the respective address line X_{S} for reading an input image signal through the respective address line Y_{S}. In the operation, the order of reading input image signals and displaying video signals may be reversed.

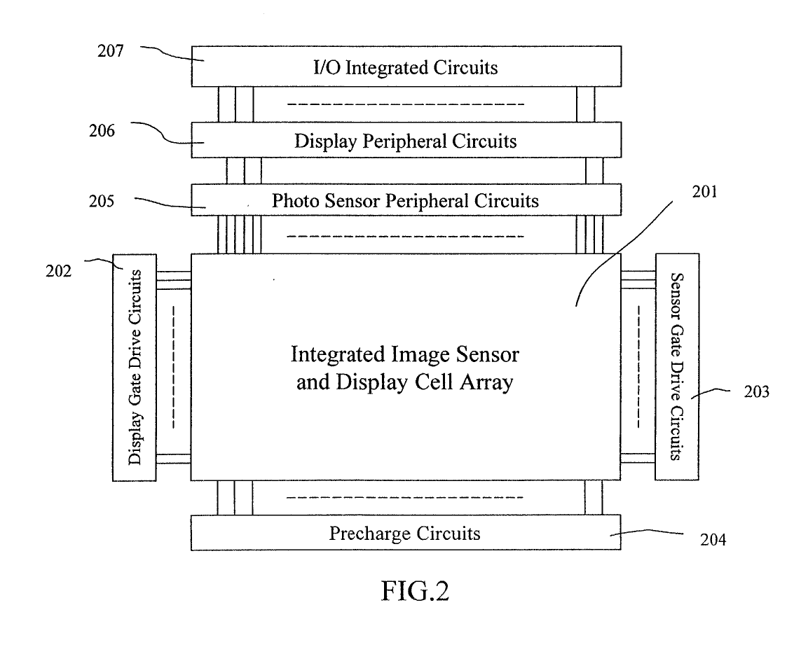

The block diagram of an integrated image sensor and display device that comprises the integrated image sensor and display active matrix array as well as the peripheral circuits of this invention is shown in FIG. 2. The integrated image sensor and display device includes an integrated image sensor and display cell array 201, display gate drive circuits 202, sensor gate drive circuits 203, precharge circuits 204, photo sensor peripheral circuits 205, display peripheral circuits 206, and I/O integrated circuits 207.

The equivalent circuit of the integrated image sensor and display cell array 201 has been shown in FIG. 1 and described earlier. The display gate drive circuits 202 and the sensor gate drive circuits 203 scan and control the horizontal address lines X_{D} and X_{S} of FIG. 1 respectively. The display peripheral circuits 206 and photo sensor peripheral circuits 205 are connected to the vertical address lines Y_{D} and Y_{S} of FIG. 1 respectively. Precharge circuits 204 are required for the precharge of the image sensor array. I/O integrated circuits 207 provide appropriate interface circuits for connecting the integrated image sensor and display to its host electronic device.

Although FIG. 1 shows separate address lines for X_{D} and X_{S}, a shared single line may be used without interfering each other as discussed earlier. In FIG. 1, the storage capacitor 105 has a ground line connected to the address line X_{D} that is also the gate line of the display thin-film transistor. The sensor diode 104 ground line can also be designed to provide the ground line for the storage capacitor 105.

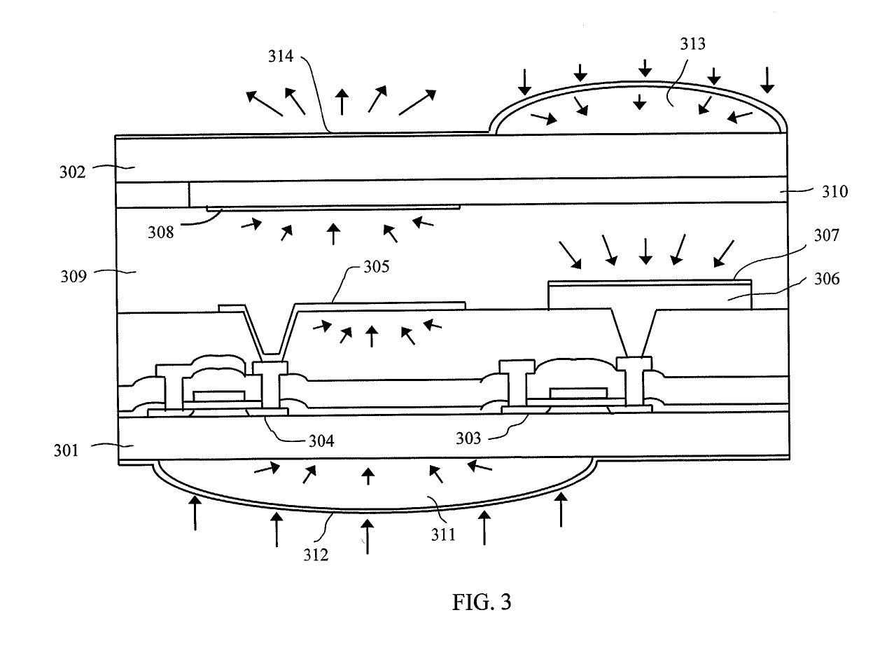

In addition to the electronic circuits as shown in FIGS. 1 and 2, the invention also provides device structure for incorporating microlens into the integrated image sensor and display. The image sensor and display cell array of FIG. 2 is manufactured on a panel having an active matrix array similar to that of an LCD display. FIG. 3 shows the cross-sectional view of the image sensor and display panel of this invention.

According to the present invention, the integrated image sensor and display panel includes a lower glass substrate 301 and an upper glass substrate 302. As illustrated in FIG. 3, semiconductor layers comprising a sensor thin-film transistor 303, a sensor diode 306, and a display thin-film transistor 304 are fabricated on top of the lower glass substrate 301 for each image sensor and display cell. The sensor diode 306 is a photodiode that is sensitive to an incident light. A first display electrode 305 is formed above and connected to the display thin-film transistor. On top of the sensor diode 306, there is also a sensor electrode 307. The preferred material of both display and sensor electrodes is ITO.

The thin film transistors 303, 304 in the active matrix array can be any type of thin film transistors such as amorphous silicon, polysilicon, CdSe or single crystalline silicon thin film transistors. The sensor diode 306 can be an amorphous silicon p-i-n, Schottky, or MOSFET type. The glass substrates 301, 302 can also be quartz or plastic substrates as long as they are transparent to light.

Above the semiconductor layers are TN liquid crystals 309 that are oriented in a normally white state for passing light. A second display electrode 308 is formed on top of the liquid crystal 309 layer in the area above the first display electrode 305. The material of the second display electrode 308 is also ITO. A color filter layer 310 is laid above the liquid crystal 309 layer. On top of the color filter layer 310 is the upper glass substrate 302. The color filter may be reflective or absorptive. A color filter plate is used for a full color type display. The color filter may also be integrated on the lower glass substrate 301, on top of the second display electrode 305, or on top of the sensor electrode 307. If the display is only monochrome, the color filter can be eliminated.

On one side of the integrated image sensor and display panel, a sensor microlens 313 is fabricated above the upper glass substrate 302 for collecting incident light to the sensor diode 306. An analyzer with or without anti-reflection /anti-glare coating 314 covers the upper glass substrate 302 and the microlens 313. The sensor microlens 313 is constructed on the panel surface facing a user to focus and direct the light signal of an outside image onto the sensor diode 306.

On the other side of the panel, a display microlens is fabricated below the lower glass substrate 301. A polarizer layer 312 is coated on the display microlens 311 and the lower glass substrate 301. The display microlens is placed on the backside of the lower glass substrate. Between the substrate and a backlight unit, the microlens acts as a focusing element to direct the backlight through a display aperture.

There are several approaches to fabricating and integrating a color filter layer into the image sensor and display device of this invention. As shown in FIG. 3, the color filter layer 310 is fabricated between the upper glass substrate 302 and liquid crystal layer 309. The color filter covers both the display electrode 305 and the sensor diode 306. In the display cell area, the color filter is between the upper glass substrate 302 and the second display electrode 308. In the sensor diode area, the color filter is between the upper glass substrate 302 and the liquid crystal layer 309.

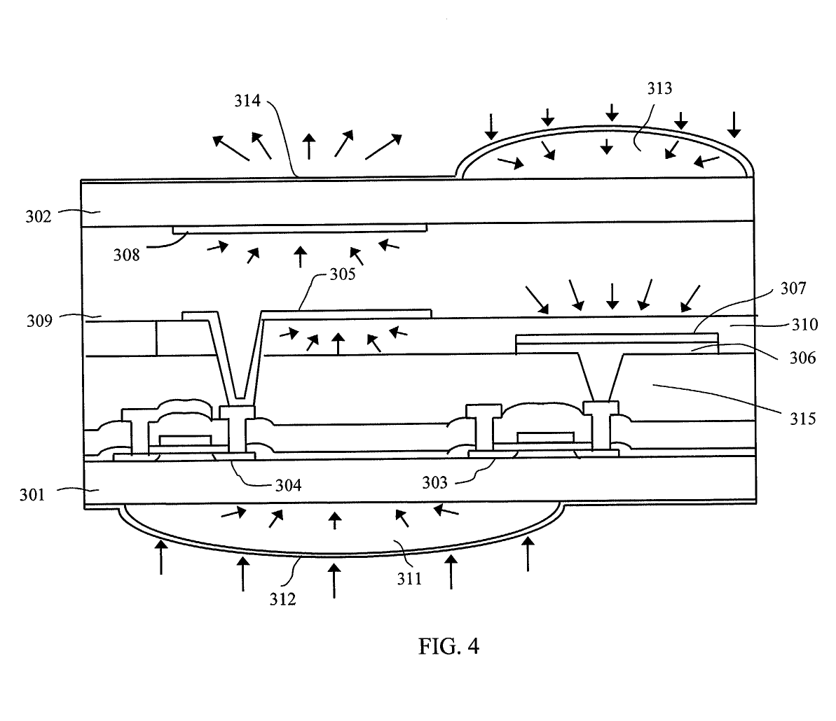

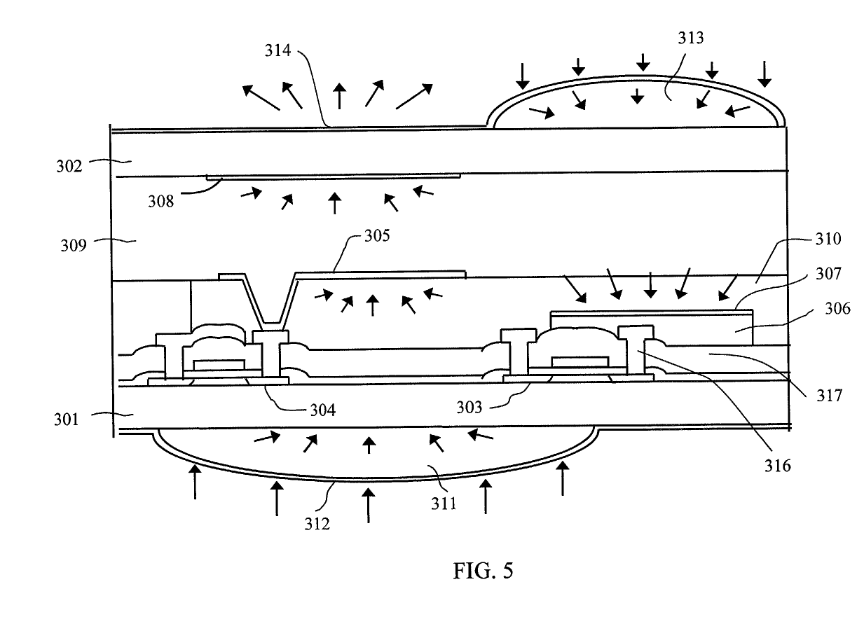

As shown in FIG. 4, the color filter layer 310 may also be fabricated below the liquid crystal layer 309 and above the lower glass substrate 301. In the display cell area, the color filter is located between the planarization layer 315 and the first display electrode 305. In the sensor diode area, the color filter is formed above the sensor electrode 307. It is also possible to eliminate the planarization layer 315 and fabricate the color filter layer 310 above the insulating layer 317 as shown in FIG. 5. In this case, the sensor diode 306 is fabricated directly on the electrode metal 316. The color filter layer 310 also serves as a planarization layer.

The integrated image sensor and display panel comprises a two dimensional array of image sensor and display units as described above. Similarly, both display microlenses and sensor microlenses are also formed as two dimensional arrays of microlenses. The display microlens array can be designed and manufactured with an offset relative to the display cell array in the two dimensional alignment. The positional offset can maximize the backlight acceptance area and allow the backlight to be focused into an open aperture of the display cell area controlled by the transparent display electrodes and the liquid crystal.

When the integrated image sensor and display panel is used to scan images of a printed or written material on a paper or other flat object, the backlight unit can be operated in such a way that it acts as a light source. By positioning the scanned object in contact with the panel, the backlight illuminates the scanned object and the image sensor can be used as a contact image sensor. On the other hand, the sensor microlens can be designed to have a focal distance for imaging objects in a normal viewing distance and working area.

The microlens can be formed by a photo sensitive type material coated on the outside of the active matrix array substrate or a cover sheet substrate with an index of refraction larger than the substrate. It may also be formed by a photo non-sensitive type material patterned by another photo sensitive material. An alternative method of manufacturing the microlens is by patterning and diffusing impurities into the transparent substrate so that the total index of refraction is increased as compared to the non-doped substrate area.

Many improvements can be made to the integrated image sensor and display panel of the present invention. For example, a black matrix can be integrated on the lower glass substrate to save usable aperture and reduce the alignment requirement for the lower and upper glass substrate. Wide viewing angle technology such as IPS, MVA, IPSVA of film type can also be applied to the panel for increasing the view angle of the display.

While the invention has been particularly shown and described with reference to these preferred embodiments, it will be understood by those skilled in the art that various changes in form and details may be made without departing from the spirit and scope of the invention as defined by the appended claims.

What is claimed is:

1. An integrated image sensor and liquid crystal display device comprising:
a first semiconductor substrate;
a display thin-film transistor formed on said first semiconductor substrate;
a first display electrode connected to said display thin-film transistor, said first display electrode being formed on said first semiconductor substrate;
a sensor thin-film transistor formed on said first semiconductor substrate;
an image sensor connected to said sensor thin-film transistor, said image sensor being formed on said first semiconductor substrate;
a sensor electrode formed above said image sensor;
a liquid crystal layer disposed above said first display electrode and said sensor electrode;
a second display electrode formed on said liquid crystal layer and above said first display electrode;
a second semiconductor substrate covering said second display electrode and said liquid crystal layer; and
a color filter layer disposed between said first and second semiconductor substrates.

2. The integrated image sensor and liquid crystal display device according to claim 1, wherein said display and sensor thin-film transistors are amorphous silicon, polysilicon, CdSe or single crystalline silicon thin-film transistors.

3. The integrated image sensor and liquid crystal display device according to claim 1, said color filter layer being disposed between said second semiconductor substrate and said second display electrode above said display thin-film transistor, and disposed between said semiconductor substrate and said liquid crystal layer above said sensor electrode.

4. The integrated image sensor and liquid crystal display device according to claim 1, said color filter layer being disposed below said liquid crystal layer and above a passivation layer, wherein said first display electrode is formed on said color filter layer above said display thin film transistor, and said sensor electrode is formed below said color filter layer.

5. The integrated image sensor and liquid crystal display device according to claim 1, said color filter layer being disposed below said liquid crystal layer and directly above an insulating layer, wherein said first display electrode is formed on said color filter layer above said display thin film transistor, said sensor electrode is formed below said color filter layer, and said color filter layer also serves as a passivation layer.

6. The integrated image sensor and liquid crystal display device according to claim 1, further comprising a sensor microlens formed above said second semiconductor substrate.

7. The integrated image sensor and liquid crystal display device according to claim 6, said sensor microlens being formed by coating a photo non-sensitive material on said second substrate or on a cover sheet substrate of said second substrate, said photo non-sensitive material being further patterned by a photo sensitive material.

8. The integrated image sensor and liquid crystal display device according to claim 6, said sensor microlens being formed by diffusing impurities into said second substrate for increasing the index of refraction of a local substrate area as compared to other non-doped area of said second substrate.

9. The integrated image sensor and liquid crystal display device according to claim 1, further comprising a display microlens formed underneath said first semiconductor substrate.

10. The integrated image sensor and liquid crystal display device according to claim 9, said display microlens being formed by coating a photo non-sensitive material on said second substrate or on a cover sheet substrate of said second substrate, said photo non-sensitive material being further patterned by a photo sensitive material.

11. The integrated image sensor and liquid crystal display device according to claim 9, said display microlens being formed by diffusing impurities into said first substrate for increasing the index of refraction of a local substrate area as compared to other non-doped area of said first substrate.
